(19) United States
(12) Patent Application Publication
(10) Pub. No.: US 2025/0037452 A1
(43) Pub. Date: Jan. 30, 2025

(54) Method of Reconstructing Multi-Source Long-Time-Series Night Light Data and System Thereof

(71) Applicants: Guangdong Ocean University, Zhanjiang City (CN); Guangdong Ecological Meteorology Center, Guangzhou City (CN)

(72) Inventors: Yu Zhang, Zhanjiang City (CN); Kunlun Xiang, Zhanjiang City (CN); Jianjun Xu, Zhanjiang City (CN); Ruozhao Deng, Zhanjiang City (CN); Yuanhong Li, Zhanjiang City (CN); Lingli Fan, Zhanjiang City (CN); Xi Lu, Zhanjiang City (CN); Yujiao Deng, Zhanjiang City (CN); Jie Xu, Zhanjiang City (CN); Junjie Feng, Zhanjiang City (CN)

(21) Appl. No.: 18/667,052

(22) Filed: May 17, 2024

(30) Foreign Application Priority Data
Jul. 28, 2023 (CN) 202310944308.0

(51) Int. Cl. G06V 20/13; G06V 10/72; G06V 20/10

(52) U.S. Cl. CPC G06V 20/13; G06V 10/72; G06V 20/176

(57) ABSTRACT

Provided is a method of reconstructing multi-source long-time-series night light data and a system thereof, relating to the field of reconstructing ecological remote sensing data. Based on night light images of a first-generation satellite DMSP/OLS (Defense Meteorological Satellite Program/Operational Line-scan System) and a second-generation satellite NPP/VIIRS (National Polar-orbiting Partnership/Visible Infrared Imaging Radiometer Suite), a method of reconstructing a set of long-time-series night light data products is developed. Since satellite images that two generations of satellites have at the same time in a certain year use an inverse hyperbolic sine transform to fit NPP/VIIRS in 2013 into a data form of DMSP/OLS, and obtain an optimal fitting equation, thus producing a set of long-time-series data products from 1992 to 2021. The method can solve a fault problem between two generations of light data of DMSP/OLS and NPP/VIRS, and improve the accuracy of data reconstruction.

### CROSS REFERENCE TO RELATED APPLICATION

This application claims the benefit of and takes priority from Chinese Patent Application No. 202310944308.0 filed on Jul. 28, 2023, the contents of which are herein incorporated by reference.

### TECHNICAL FIELD

The present disclosure relates to the field of reconstructing ecological remote sensing data, in particular to a method of reconstructing multi-source long-time-series night light data based on DMSP/OLS and NPP/VIIRS and a system thereof.

### BACKGROUND

A night light index is timely and economical, which can characterize the level of urbanization from a macro perspective and is an important indicator of the level of economic development. Both DMSP/OLS (Defense Meteorological Satellite Program/Operational Line-scan System) and NPP/VIIRS (National Polar-orbiting Partnership/Visible Infrared Imaging Radiometer Suite) are night light data from NOAA, but these two sets of data sources have long been affected by data faults, so that it is difficult to establish continuous and consistent data sets and apply them to the research of a long-time series. At present, the research on the integration of consistency of two sets of light data is as follows. Li et al. proposed a mutual correction model based on a power function and a Gaussian low-pass filter to integrate the data of DMSP/OLS and NPP/VIIRS, and explore the changes of light brightness in human settlements before and after the Syrian civil war from 2011 to 2017. However, this method does not have universal data accessibility. Ma et al. and Zhao et al. put forward a new integrating model, which simulates the DMSP/OLS data after 2013 with NPP/VIIRS data based on a logical function model. The accuracy of this model can reach over 95%. Yu et al. integrated the night light data set of the Yangtze River Delta urban agglomerations from 2001 to 2019 based on this model, and explored the temporal and spatial heterogeneity of urbanization in the Yangtze River Delta urban agglomerations. These researches have solved the inconsistency between the data of DMSP/OLS and NPP/VIIRS in some specific regions, but the applicability of these methods is uncertain for other regions.

### SUMMARY

The present disclosure aims to provide a method of reconstructing multi-source long-time-series night light data and a system thereof, which can solve a fault problem between two generations of light data of DMSP/OLS and NPP/VIRS, and improve the accuracy of data reconstruction.

In order to achieve the above purpose, the present disclosure provides the following scheme.

The present disclosure provides a method of reconstructing multi-source long-time-series night light data, wherein the method includes:
acquiring a DMSP/OLS night light data set and an NPP/VIIRS night light data set of a target area, and carrying out unified spatial resolution preprocessing;
carrying out mutual correction of data among sensors for the preprocessed DMSP/OLS night light data set;
carrying out data continuity correction for the DMSP/OLS night light data set corrected among sensors;
carrying out continuity correction for the preprocessed NPP/VIIRS night light data set;
applying an inverse hyperbolic sine transform for data fitting according to an overlapping period data set between the corrected DMSP/OLS night light data set and the corrected NPP/VIIRS night light data set to obtain a data fitting model;
applying the data fitting model to the NPP/VIIRS night light data set in a non-overlapping time period to obtain the DMSP/OLS night light data set fitted in the non-overlapping time period; wherein the DMSP/OLS night light data set fitted in an overlapping period and the DMSP/OLS night light data set fitted in the non-overlapping period form a complete reconstructed light data set;
integrating the reconstructed light data set and the DMSP/OLS night light data set to obtain complete data after multi-source integration.

Preferably, acquiring a DMSP/OLS night light data set and an NPP/VIIRS night light data set of a target area and carrying out unified spatial resolution preprocessing specifically includes:
re-projecting the DMSP/OLS night light data set in a first preset year period and the NPP/VIIRS night light data set in a second preset year period onto an Albers equal area projection in a preset area, respectively;
re-sampling pixels of the re-projected DMSP/OLS night light data set and the re-projected NPP/VIIRS night light data set based on a nearest neighbor method;
clipping data of the resampled DMSP/OLS night light data set and the resampled NPP/VIIRS night light data set according to boundary data of the target area, respectively, to obtain the preprocessed DMSP/OLS night light data set and the preprocessed NPP/VIIRS night light data set.

Preferably, carrying out mutual correction of data among sensors for the preprocessed DMSP/OLS night light data set specifically includes:
correcting data in each period of each sensor corresponding to the preprocessed DMSP/OLS night light data set based on a sequential correcting method of a pseudo-invariant area to obtain the DMSP/OLS night light data set corrected among the sensors.

Preferably, correcting data in each period of each sensor corresponding to the preprocessed DMSP/OLS night light data set based on a sequential correcting method of a pseudo-invariant area specifically includes:
determining a reference sensor from each sensor corresponding to the preprocessed DMSP/OLS night light data set;
calculating sensor data of each period of a non-reference sensor in sequence by using a quadratic nonlinear regression equation with one unknown, and obtaining the DMSP/OLS night light data set corrected among the sensors.

Preferably, carrying out data continuity correction for the DMSP/OLS night light data set corrected among sensors specifically includes:
processing data of the DMSP/OLS night light data set in overlapping years of the sensors by a pixel-by-pixel averaging method according to the DMSP/OLS night light data set corrected among sensors to obtain the averaged DMSP/OLS night light data set;
carrying out continuity correction for the averaged DMSP/OLS night light data set according to the DMSP/OLS night light data set corresponding to the reference sensor as a reference.

Preferably, carrying out continuity correction for the averaged DMSP/OLS night light data set according to the DMSP/OLS night light data set corresponding to the reference sensor as a reference specifically includes:
carrying out continuity correction for the DMSP/OLS night light data set of the year before the year corresponding to the reference sensor in sequence by using a first formula year by year; wherein the first formula is

$${DN}_{( yr - 1 , i )} \{ \begin{matrix}{DN}_{( yr , i )} & {DN}_{( yr - 1 , i )} > {DN}_{( yr , i )} \\ {DN}_{( yr - 1 , i )} & otherwise\end{matrix} ;$$

carrying out continuity correction for the DMSP/OLS night light data set of the year after the year corresponding to the reference sensor in sequence by using a second formula year by year; wherein the second formula is

$${DN}_{( yr + 1 , i )} \{ \begin{matrix}{DN}_{( yr , i )} & {DN}_{( yr , i )} > {DN}_{( yr + 1 , i )} \\ {DN}_{( yr + 1 , i )} & otherwise\end{matrix} .$$

Preferably, prior to carrying out continuity correction for the preprocessed NPP/VIIRS night light data set, the method further includes:
using a T0.3 mask method to screen out light pixels with light brightness above a first preset value and below a second preset value from the preprocessed NPP/VIIRS night light data set to obtain the denoised NPP/VIIRS night light data set.

Preferably, applying an inverse hyperbolic sine transform for data fitting according to an overlapping period data set between the corrected DMSP/OLS night light data set and the corrected NPP/VIIRS night light data set to obtain a data fitting model specifically includes:
determining the overlapping period data set between the corrected DMSP/OLS night light data set and the corrected NPP/VIIRS night light data set;
carrying out an inverse hyperbolic sine transform for the NPP/VIIRS night light data set in the overlapping period;
fitting the NPP/VIIRS night light data set after the inverse hyperbolic sine transform in the overlapping period and the DMSP/OLS night light data set in the overlapping period by using a sigmoid logic function to obtain the data fitting model; the NPP/VIIRS night light data set after the inverse hyperbolic sine transform in the overlapping period is the fitted DMSP/OLS night light data set in the overlapping period.

Preferably, the expression of the inverse hyperbolic sine transform is:

$$NPP / {VIIRS}_{new} = IHS ( NPP / VIIRS ) = ln ( NPP / VIIRS + \sqrt{NPP / {VIIRS}^{2} + 1} ) ;$$

the expression of the sigmoid logic function is:

$$f ( x ) = \frac{a}{1 + {e}^{b * NPP / {VIIRS}_{new} + c}} .$$

The present disclosure further provides a system of reconstructing multi-source long-time-series night light data, wherein the system includes:
a data acquiring and preprocessing module, which is configured to acquire a DMSP/OLS night light data set and an NPP/VIIRS night light data set of a target area, and carry out unified spatial resolution preprocessing;
a first correcting module, which is configured to carry out mutual correction of data among sensors for the preprocessed DMSP/OLS night light data set;
a second correcting module, which is configured to carry out data continuity correction for the DMSP/OLS night light data set corrected among sensors;
a third correcting module, which is configured to carry out continuity correction for the preprocessed NPP/VIIRS night light data set;
a fitting module, which is configured to apply an inverse hyperbolic sine transform for data fitting according to an overlapping period data set between the corrected DMSP/OLS night light data set and the corrected NPP/VIIRS night light data set to obtain a data fitting model;
a data reconstructing module, which is configured to apply the data fitting model to the NPP/VIIRS night light data set in a non-overlapping time period to obtain the DMSP/OLS night light data set fitted in the non-overlapping time period; wherein the DMSP/OLS night light data set fitted in an overlapping period and the DMSP/OLS night light data set fitted in the non-overlapping period form a complete reconstructed light data set;
a multi-source data integrating module, which is configured to integrate the reconstructed light data set and the DMSP/OLS night light data set to obtain complete data after multi-source integration.

According to the specific embodiment provided by the present disclosure, the present disclosure provides the following technical effects.

The present disclosure provides a method of reconstructing multi-source long-time-series night light data and a system thereof. An optimal fitting model is obtained by fitting DMSP/OLS through NPP/VIIRS (i.e. HIS (NPP/VIIRS)) after being processed by an inverse hyperbolic sine transform. The pixel-by-pixel fitting precision of the model is high, and two generations of night light data of DMSP/OLS and NPP/VIRS can be further integrated, so as to solve the fault problem between the current mainstream two generations of light data of DMSP/OLS and NPP/VIRS, and obtain a set of multi-source reconstructing and continuous and consistent night lighting data products.

### BRIEF DESCRIPTION OF THE DRAWINGS

In order to explain the embodiments of the present disclosure or the technical schemes in the prior art more clearly, the drawings that need to be used in the embodiments will be briefly introduced. Obviously, the drawings in the following description are only some embodiments of the present disclosure. For those skilled in the art, other drawings can be obtained according to these drawings without creative labor.

FIG. 1 is a flowchart of a method of reconstructing multi-source long-time-series night light data according to Embodiment 1 of the present disclosure.

FIG. 2(a)-FIG. 2(d) are comparison diagrams of fitting results of a data fitting model based on different fitting methods according to Embodiment 1 of the present disclosure.

FIG. 3 is a night light diagram of Guangdong-Hong Kong-Macao Greater Bay Area in 2021 in complete data after multi-source integration obtained by a multi-source data integrating module according to Embodiment 1 of the present disclosure.

### DETAILED DESCRIPTION OF THE EMBODIMENTS

The technical schemes in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments obtained by those skilled in the art without creative labor fall within the scope of protection of the present disclosure.

The present disclosure aims to provide a method of reconstructing multi-source long-time-series night light data and a system thereof, which can solve a fault problem between two generations of light data of DMSP/OLS and NPP/VIRS, and improve the accuracy of data reconstruction.

In order to make the above objects, features and advantages of the present disclosure more obvious and understandable, the present disclosure will be explained in further detail with reference to the drawings and detailed description hereinafter.

### Embodiment 1

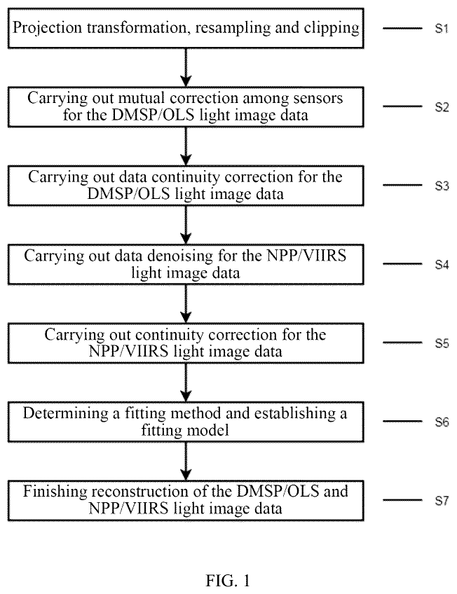

As shown in FIG. 1, this embodiment provides a method of reconstructing multi-source long-time-series night light data, taking Guangdong-Hong Kong-Macao Greater Bay Area as an example, which specifically includes the following steps.

S1: a DMSP/OLS night light data set and an NPP/VIIRS night light data set of a target area are acquired, and unified spatial resolution preprocessing is carried out.

Projection transformation, resampling and clipping of DMSP/OLS and NPP/VIIRS original light image data sets are as follows.

First, the original NPP/VIIRS light image data from 2013 to 2021 month by month are averaged year by year, and the original NPP/VIIRS light image data set from 2013 to 2021 year by year (a total of 9 remote sensing images) is obtained. 34 original light image data sets of F10-F18 of DMSP/OLS from 1992 to 2013 year by year and 9 original light image data sets of NPP/VIIRS from 2013 to 2021 year by year are re-projected on the Albers equal area projection (central meridian 105° E, and standard latitude 25° N, 47° N) suitable for China area, respectively. Thereafter, the pixels are re-sampled based on the nearest neighbor method, and are reduced to raster pixels with 1 km resolution, so that all light image data can be unified in spatial resolution. At last, all the light image data are clipped with administrative boundary raster data of Guangdong-Hong Kong-Macao Greater Bay Area, and the original DMSP/OLS and NPP/VIIRS light image data sets of Guangdong-Hong Kong-Macao Greater Bay Area are obtained.

Step S1 is summarized as follows:
(1) re-projecting the DMSP/OLS night light data set in a first preset year period and the NPP/VIIRS night light data set in a second preset year period onto an Albers equal area projection in a preset area, respectively;
(2) re-sampling pixels of the re-projected DMSP/OLS night light data set and the re-projected NPP/VIIRS night light data set based on a nearest neighbor method;
(3) clipping data of the resampled DMSP/OLS night light data set and the resampled NPP/VIIRS night light data set according to boundary data of the target area, respectively, to obtain the preprocessed DMSP/OLS night light data set and the preprocessed NPP/VIIRS night light data set.

S2: mutual correction of data among sensors is carried out for the preprocessed DMSP/OLS night light data set.

Data in each period of each sensor corresponding to the preprocessed DMSP/OLS night light data set is corrected based on a sequential correcting method of a pseudo-invariant area to obtain the DMSP/OLS night light data set corrected among the sensors, specifically including:
determining a reference sensor from each sensor corresponding to the preprocessed DMSP/OLS night light data set;
calculating sensor data of each period of a non-reference sensor in sequence by using a quadratic nonlinear regression equation with one unknown, and obtaining the DMSP/OLS night light data set corrected among the sensors.

In Step S2, 34 light image data of F10-F18 of DMSP/OLS from 1992 to 2013 year by year are corrected among different sensors. Based on the sequential correcting method of the pseudo-invariant area, F16 is used as the standard sensor, and the quadratic nonlinear regression equation with one unknown (DN′=a×DN₀²+b×DN₀+c) is used, where DN′ is the result of mutual correction, DN₀ is the gray value of the original image, a, b and c are the coefficients of the regression equation. The data of sensors (F15, F14, F12, F10 and F18) in other periods are calculated in sequence.

DMSP/OLS is provided with 6 sensors (F10, F12, F14, F15, F16 and F18) is total. Taking F16 as the standard sensor, the specific process of correcting the other five sensors in sequence is as follows.
(1) The data of F16 is used to correct the data of F15. The overlapping year is from 2004to 2007. Taking F16₂₀₀₄ to F16₂₀₀₇ data as the reference data set, quadratic regression with one unknown is modelled for the F15₂₀₀₄ to F15₂₀₀₇ data set and the reference data set based on the least square method. The regression equation is DN₁₆=a×DN²₁₅+b×DN₁₅+c, where DN₁₆ is the DN value of the F16₂₀₀₄ to F16₂₀₀₇ reference data set; DN₁₅ is the DN value of the F15₂₀₀₄ to F15₂₀₀₇ data set; a, b and c are the parameters determined in the fitting process.
(2) The equation DN′=a×DN²₀+b×DN⁰+c of the correction sensor F15 is constructed by using the obtained parameters a, b and c, where DN₀ is the DN value of F15 before correction and DN′ is the DN value after correction. Using this equation, the F15₂₀₀₀ to F15₂₀₀₇ light data set is processed, and the data set F15′ after mutual correction is obtained.
(3) Thereafter, the data set of F15′ is used to correct the data set of the F14 sensor, and the method is the same as above to obtain F14′. Likewise, correction is made in sequence to obtain data sets F12′ and F10′.
(4) The sensor F18 is corrected. Since F16 and F18 have no data of the overlapping year, F16₂₀₀₉ data and F18₂₀₁₀ data are used to model quadratic regression with one unknown: DN₁₈=a×DN²₁₆+b×DN₁₅+c, where DN₁₈ is the DN value of F18₂₀₁₀ data, DN₁₈ is the DN value of F18₂₀₁₀ data, and a, b and c are parameters determined in the fitting process. Thereafter, the established equation is also used to correct the data of F18 in each period, and the mutually corrected data set F18′ is obtained.
(5) Refer to the following table for fitting parameters a, b and c in each period:

TABLE 1
Parameters of a sensor correction regression model

| Data set | a | b | c | SSE | R² |
|---|---|---|---|---|---|
| F16→F15 | −0.001 447 | 1.091 | 0.913 | 8.531e+04 | 0.930 9 |
| F15→F14 | −0.003 202 | 1.093 | 1.766 | 1.523e+05 | 0.864 6 |
| F14→F12 | 0.003 413 | 0.628 | 2.717 | 2.337e+04 | 0.956 4 |
| F12→F10 | 0.001 906 | 0.832 | 0.886 | 1.255e+04 | 0.917 1 |
| F16→F18 | 0.004 262 | 0.673 | 0.766 | 5.901e+04 | 0.895 5 |

S3: data continuity correction is carried out for the DMSP/OLS night light data set corrected among sensors.

34 light image data of F10-F18 of DMSP/OLS from 1992 to 2013 year by year are corrected among different years. The light image data of the sensor in the overlapping years (1994, 1997-2007) are processed by a pixel-by-pixel averaging method (DN_{(yr,i)}=(DN_{(yr,i)}^{s1}+DN_{(yr,i)}^{s2})/2), and 22 light image data of DMSP/OLS from 1992 to 2013 year by year (one for each year) is obtained. DN_{(yr,i)} denotes the pixel DN value of an i-th grid point of a night light data in a certain year, and S1 and S2 denote two different sensors. The light image data of F16 in 2009 with good stability is then selected as the reference. Continuity correction is carried out for the 22 light image data of DMSP/OLS year by year. For the light image data before 2009, the DMSP/OLS night light data from 2008 to 1992 is corrected in sequence year by year by using a first formula

$$( {DN}_{( yr - 1 , i )} \{ \begin{matrix}{DN}_{( yr , i )} & {DN}_{( yr - 1 , i )} > {DN}_{( yr , i )} \\ {DN}_{( yr - 1 , i )} & otherwise\end{matrix} ) .$$

The pixel-by-pixel light brightness in the light image data before 2009 should decrease year by year. For the data after 2009, the DMSP/OLS night light data from 2010 to 2013 is corrected in sequence year by year by using a second formula

$$( {DN}_{( yr + 1 , i )} \{ \begin{matrix}{DN}_{( yr , i )} & {DN}_{( yr , i )} > {DN}_{( yr + 1 , i )} \\ {DN}_{( yr + 1 , i )} & otherwise\end{matrix} ) .$$

The pixel-by-pixel light brightness in the light image data after 2009 should increase year by year. The value yr−1 has a range of 1992, 1993, . . . , 2008, and DN_{(yr-1,i)} is the pixel DN value of the i-th grid point of the night light data one year before DN_{(yr,i)}. The value Yr+1 has a range of 2010, 2011, 2012 and 2013. DN(yr+1,i) is the pixel DN value of the i-th grid point of the night light data one year after DN_{(yr,i)}.

Step S3 is summarized as follows:
(1) processing data of the DMSP/OLS night light data set in overlapping years of the sensors by a pixel-by-pixel averaging method according to the DMSP/OLS night light data set corrected among sensors to obtain the averaged DMSP/OLS night light data set;
(2) carrying out continuity correction for the averaged DMSP/OLS night light data set according to the DMSP/OLS night light data set corresponding to the reference sensor as a reference.

Carrying out continuity correction for the averaged DMSP/OLS night light data set according to the DMSP/OLS night light data set corresponding to the reference sensor as a reference specifically includes:
1) carrying out continuity correction for the DMSP/OLS night light data set of the year before the year corresponding to the reference sensor in sequence by using a first formula year by year;
2) carrying out continuity correction for the DMSP/OLS night light data set of the year after the year corresponding to the reference sensor in sequence by using a second formula year by year.

S4: continuity correction is carried out for the preprocessed NPP/VIIRS night light data set, specifically including:
using a T0.3 mask method to screen out light pixels with light brightness above a first preset value and below a second preset value from the preprocessed NPP/VIIRS night light data set to obtain the denoised NPP/VIIRS night light data set.

Taking Guangdong-Hong Kong-Macao Greater Bay Area as an example, the T0.3 mask method is used to screen out the light pixels with the light brightness above the light DN value of 0.3×10−9 W cm−2sr−1 and below the maximum light DN in Beijing, Shanghai or Guangzhou in 2013 to 2021 from 9 light image data of NPP/VIIRS from 2013 to 2021 year by year. The T0.3 mask is used to denoise NPP/VIIRS data, and eliminate the influence of unstable light source and background noise.

S5: continuity correction is carried out for the preprocessed NPP/VIIRS night light data set.

Taking the NPP/VIIRS light image data in 2013 as a reference, the NPP/VIIRS light image data from 2014 to 2021 is corrected year by year by using the formula

$$( {DN}_{( yr + 1 , i )} \{ \begin{matrix}{DN}_{( yr , i )} & {DN}_{( yr , i )} > {DN}_{( yr + 1 , i )} \\ {DN}_{( yr + 1 , i )} & otherwise\end{matrix} ) ,$$

and the pixel-by-pixel light brightness in the light image data of each year after 2013 should increase year by year.

S6: an inverse hyperbolic sine transform is applied for data fitting according to an overlapping period data set between the corrected DMSP/OLS night light data set and the corrected NPP/VIIRS night light data set to obtain a data fitting model; and the data fitting model is applied to the NPP/VIIRS night light data set in a non-overlapping time period to obtain the DMSP/OLS night light data set fitted in the non-overlapping time period; wherein the DMSP/OLS night light data set fitted in an overlapping period and the DMSP/OLS night light data set fitted in the non-overlapping period form a complete reconstructed light data set.

First, the light image data of DMSP/OLS and NPP/VIIRS in 2013 in which the data of DMSP/OLS and NPP/VIIRS overlap are selected; second, based on the NPP/VIIRS data in 2013, the DMSP/OLS light image data in 2013 is fitted, and the inverse hyperbolic sine transform NPP/VIIRS_{new}=IHS(NPP/VIIRS)=ln(NPP/VIIRS+\sqrt{NPP/VIIRS^{a}+1}) is applied for the NPP/VIIRS data in 2013, where NPP/VIIRS_{new} is the pixel brightness DN value of the NPP/VIIRS data after the inverse hyperbolic sine transform; the sigmoid logic function

$$f ( x ) = \frac{a}{1 + {e}^{b * NPP / {VIIRS}_{new} + c}}$$

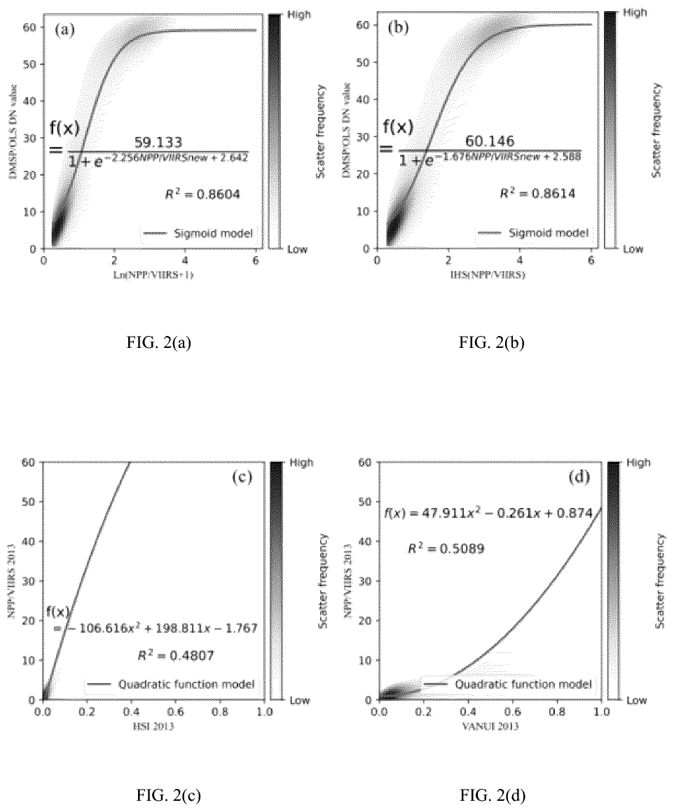

(a, b and c are the model fitting coefficients) is used to fit the DMSP/OLS data in 2013, and the optimal fitting model is established. The fitting model result is shown in FIG. 2(b). FIG. 2(a) applies a logical function model to the logarithmically transformed NPP/VIIRS data for fitting; FIG. 2(b) applies a logical function model to the NPP/VIIRS data after an inverse hyperbolic sine (IHS) transform for fitting; FIG. 2(c) applies a quadratic function model to the DMSP/OLS data desaturated by the HSI method for fitting; and FIG. 2(d) applies a quadratic function model to the DMSP/OLS data desaturated by the VANUI method for fitting. Thereafter, the NPP/VIIRS light image data from 2014 to 2021 is input year by year, and is reconstructed by using a fitting model. The reconstructed light data set from 2013 to 2021 is output. The NPP/VIIRS data from 2014 to 2021 is fitted, so that the model

$$f ( x ) = \frac{a}{1 + {e}^{b * NPP / {VIIRS}_{new} + c}}$$

is used to fit and calculate the NPP/VIIRS data from 2014 to 2021 year by year, thereby obtaining the reconstructed series of light data sets from 2014 to 2021.

The process of obtaining the data fitting model in Step S6 is summarized as follows:
(1) determining the overlapping period data set between the corrected DMSP/OLS night light data set and the corrected NPP/VIIRS night light data set;
(2) carrying out an inverse hyperbolic sine transform for the NPP/VIIRS night light data set in the overlapping period;
(3) fitting the NPP/VIIRS night light data set after the inverse hyperbolic sine transform in the overlapping period and the DMSP/OLS night light data set in the overlapping period by using a sigmoid logic function to obtain the data fitting model; the NPP/VIIRS night light data set after the inverse hyperbolic sine transform in the overlapping period is the fitted DMSP/OLS night light data set in the overlapping period.

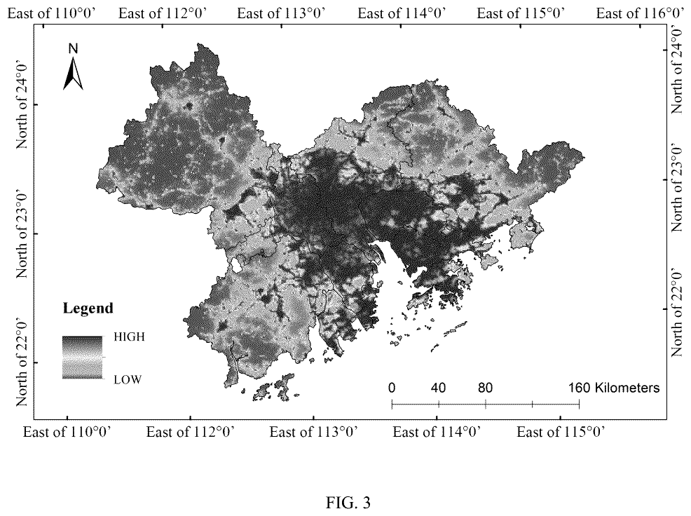

S7: the reconstructed light data set and the DMSP/OLS night light data set are integrated to obtain complete data after multi-source integration. The data in 2021 is output and visualized to obtain FIG. 3, and the data in other years is output and visualized to obtain images similar to FIG. 3.

The reconstructed light data set from 2013 to 2021 is integrated with the DMSP/OLS light image data set from 1992 to 2013, and a complete light image data set of Guangdong-Hong Kong-Macao Greater Bay Area from 1992 to 2021 is obtained.

This method is also applicable to the integration of two generations of night light data of DMSP/OLS and NPP/VIRS in other areas outside Guangdong-Hong Kong-Macao Greater Bay Area for a long time series.

According to the above method of reconstructing light data, two generations of night light data of DMSP/OLS and NPP/VIRS can be integrated for a long time series.

Taking Guangdong-Hong Kong-Macao Greater Bay Area as an example, in this embodiment, based on the night light data of DMSP/OLS and NPP/VIRS, the DMSP/OLS is fitted by T0.3 mask denoising and NPP/VIRS after the inverse hyperbolic sine transform (IHS (NPP/VIRS)), and the optimal fitting model is obtained. The model is used to fit the NPP/VIIRS data set to obtain a series of light data sets from 2013 to 2021, which are then integrated with the DMSP/OLS light data sets from 1992 to 2013 to obtain the continuous and consistent night light data sets from 1992 to 2021 in Guangdong-Hong Kong-Macao Greater Bay Area. This provides a scientific basis for building a scientific and reasonable urban architecture and optimizing the spatial pattern of urban expansion. The verification results show that in this method, the correlation R2 between the light index and GDP is 0.96, and the correlation R2 between the light index and the urban built-up area is 0.93. It can be seen that this method has the characteristics of a high precision and a good fitting effect, which better solves the problems existing in the prior art and effectively improves the accuracy of the method of integrating and reconstructing long-time-series light data.

Compared with the prior art, the present disclosure has the following beneficial effects.
(1) In this method, the DMSP/OLS is fitted by T0.3 mask denoising and NPP/VIRS after the inverse hyperbolic sine transform (IHS (NPP/VIRS)), and the optimal fitting model is obtained. The pixel-by-pixel fitting effect of the model is better than that of the same type of methods.
(2) The method can solve the fault problem between the current mainstream two generations of light data of DMSP/OLS and NPP/VIRS, and obtain a set of continuous and consistent night lighting data products in Guangdong-Hong Kong-Macao Greater Bay Area from 1992 to 2021. This set of products has high correlation with statistical data such as GDP and the urban built-up area.

### Embodiment 2

This embodiment provides a system of reconstructing multi-source long-time-series night light data, wherein the system includes:
a data acquiring and preprocessing module, which is configured to acquire a DMSP/OLS night light data set and an NPP/VIIRS night light data set of a target area, and carry out unified spatial resolution preprocessing;
a first correcting module, which is configured to carry out mutual correction of data among sensors for the preprocessed DMSP/OLS night light data set;
a second correcting module, which is configured to carry out data continuity correction for the DMSP/OLS night light data set corrected among sensors;
a third correcting module, which is configured to carry out continuity correction for the preprocessed NPP/VIIRS night light data set;
a fitting module, which is configured to apply an inverse hyperbolic sine transform for data fitting according to an overlapping period data set between the corrected DMSP/OLS night light data set and the corrected NPP/VIIRS night light data set to obtain a data fitting model;
a data reconstructing module, which is configured to apply the data fitting model to the NPP/VIIRS night light data set in a non-overlapping time period to obtain the DMSP/OLS night light data set fitted in the non-overlapping time period; wherein the DMSP/OLS night light data set fitted in an overlapping period and the DMSP/OLS night light data set fitted in the non-overlapping period form a complete reconstructed light data set;
a multi-source data integrating module, which is configured to integrate the reconstructed light data set and the DMSP/OLS night light data set to obtain complete data after multi-source integration.

The same and similar parts of various embodiments can be referred to each other. Since the system provided in the embodiment corresponds to the method provided in the embodiment, the system is described simply. Refer to the description of the method for the relevant points.

In the present disclosure, specific examples are applied to illustrate the principle and implementation of the present disclosure, and the explanations of the above embodiments are only used to help understand the method and core ideas of the present disclosure. At the same time, according to the idea of the present disclosure, there will be some changes in the specific implementation and application scope for those skilled in the art. To sum up, the contents of the specification should not be construed as limiting the present disclosure.

What is claimed is:

1. A method of reconstructing multi-source long-time-series night light data, wherein the method comprises:
acquiring a DMSP/OLS (Defense Meteorological Satellite Program/Operational Line-scan System) night light data set and an NPP/VIIRS (National Polar-orbiting Partnership/Visible Infrared Imaging Radiometer Suite) night light data set of a target area, and carrying out unified spatial resolution preprocessing;
carrying out mutual correction of data among sensors for the preprocessed DMSP/OLS night light data set;
carrying out data continuity correction for the DMSP/OLS night light data set corrected among sensors;
carrying out continuity correction for the preprocessed NPP/VIIRS night light data set;
applying an inverse hyperbolic sine transform for data fitting according to an overlapping period data set between the corrected DMSP/OLS night light data set and the corrected NPP/VIIRS night light data set to obtain a data fitting model;
applying the data fitting model to the NPP/VIIRS night light data set in a non-overlapping time period to obtain the DMSP/OLS night light data set fitted in the non-overlapping time period; wherein the DMSP/OLS night light data set fitted in an overlapping period and the DMSP/OLS night light data set fitted in the non-overlapping period form a complete reconstructed light data set;
integrating the reconstructed light data set and the DMSP/OLS night light data set to obtain complete data after multi-source integration.

2. The method according to claim 1, wherein acquiring a DMSP/OLS night light data set and an NPP/VIIRS night light data set of a target area and carrying out unified spatial resolution preprocessing specifically comprises:
re-projecting the DMSP/OLS night light data set in a first preset year period and the NPP/VIIRS night light data set in a second preset year period onto an Albers equal area projection in a preset area, respectively;
re-sampling pixels of the re-projected DMSP/OLS night light data set and the re-projected NPP/VIIRS night light data set based on a nearest neighbor method;
clipping data of the resampled DMSP/OLS night light data set and the resampled NPP/VIIRS night light data set according to boundary data of the target area, respectively, to obtain the preprocessed DMSP/OLS night light data set and the preprocessed NPP/VIIRS night light data set.

3. The method according to claim 1, wherein carrying out mutual correction of data among sensors for the preprocessed DMSP/OLS night light data set specifically comprises:
correcting data in each period of each sensor corresponding to the preprocessed DMSP/OLS night light data set based on a sequential correcting method of a pseudo-invariant area to obtain the DMSP/OLS night light data set corrected among the sensors.

4. The method according to claim 3, wherein correcting data in each period of each sensor corresponding to the preprocessed DMSP/OLS night light data set based on a sequential correcting method of a pseudo-invariant area specifically comprises:
determining a reference sensor from each sensor corresponding to the preprocessed DMSP/OLS night light data set;
calculating sensor data of each period of a non-reference sensor in sequence by using a quadratic nonlinear regression equation with one unknown, and obtaining the DMSP/OLS night light data set corrected among the sensors.

5. The method according to claim 4, wherein carrying out data continuity correction for the DMSP/OLS night light data set corrected among sensors specifically comprises:
processing data of the DMSP/OLS night light data set in overlapping years of the sensors by a pixel-by-pixel averaging method according to the DMSP/OLS night light data set corrected among sensors to obtain the averaged DMSP/OLS night light data set;
carrying out continuity correction for the averaged DMSP/OLS night light data set according to the DMSP/OLS night light data set corresponding to the reference sensor as a reference.

6. The method according to claim 5, wherein carrying out continuity correction for the averaged DMSP/OLS night light data set according to the DMSP/OLS night light data set corresponding to the reference sensor as a reference specifically comprises:
carrying out continuity correction for the DMSP/OLS night light data set of the year before the year corresponding to the reference sensor in sequence by using a first formula year by year; wherein the first formula is
$${DN}_{( yr - 1 , i )} \{ \begin{matrix}{DN}_{( yr , i )} & {DN}_{( yr - 1 , i )} > {DN}_{( yr , i )} \\ {DN}_{( yr - 1 , i )} & otherwise\end{matrix} ;$$
carrying out continuity correction for the DMSP/OLS night light data set of the year after the year corresponding to the reference sensor in sequence by using a second formula year by year; wherein the second formula is
$${DN}_{( yr + 1 , i )} \{ \begin{matrix}{DN}_{( yr , i )} & {DN}_{( yr , i )} > {DN}_{( yr + 1 , i )} \\ {DN}_{( yr + 1 , i )} & otherwise\end{matrix} .$$

7. The method according to claim 6, wherein prior to carrying out continuity correction for the preprocessed NPP/VIIRS night light data set, the method further comprises:
using a T0.3 mask method to screen out light pixels with light brightness above a first preset value and below a second preset value from the preprocessed NPP/VIIRS night light data set to obtain the denoised NPP/VIIRS night light data set.

8. The method according to claim 1, wherein applying an inverse hyperbolic sine transform for data fitting according to an overlapping period data set between the corrected DMSP/OLS night light data set and the corrected NPP/VIIRS night light data set to obtain a data fitting model specifically comprises:
determining the overlapping period data set between the corrected DMSP/OLS night light data set and the corrected NPP/VIIRS night light data set;
carrying out an inverse hyperbolic sine transform for the NPP/VIIRS night light data set in the overlapping period;
fitting the NPP/VIIRS night light data set after the inverse hyperbolic sine transform in the overlapping period and the DMSP/OLS night light data set in the overlapping period by using a sigmoid logic function to obtain the data fitting model; the NPP/VIIRS night light data set after the inverse hyperbolic sine transform in the overlapping period is the fitted DMSP/OLS night light data set in the overlapping period.

9. The method according to claim 8, wherein the expression of the inverse hyperbolic sine transform is:
$$NPP / {VIIRS}_{new} = IHS ( NPP / VIIRS ) = ln ( NPP / VIIRS + \sqrt{NPP / {VIIRS}^{2} + 1} ) ;$$
the expression of the sigmoid logic function is:
$$f ( x ) = \frac{a}{1 + {e}^{b * NPP / {VIIRS}_{new} + c}} .$$

10. A system of reconstructing multi-source long-time-series night light data, wherein the system comprises:
a data acquiring and preprocessing module, which is configured to acquire a DMSP/OLS night light data set and an NPP/VIIRS night light data set of a target area, and carry out unified spatial resolution preprocessing;
a first correcting module, which is configured to carry out mutual correction of data among sensors for the preprocessed DMSP/OLS night light data set;
a second correcting module, which is configured to carry out data continuity correction for the DMSP/OLS night light data set corrected among sensors;
a third correcting module, which is configured to carry out continuity correction for the preprocessed NPP/VIIRS night light data set;
a fitting module, which is configured to apply an inverse hyperbolic sine transform for data fitting according to an overlapping period data set between the corrected DMSP/OLS night light data set and the corrected NPP/VIIRS night light data set to obtain a data fitting model;
a data reconstructing module, which is configured to apply the data fitting model to the NPP/VIIRS night light data set in a non-overlapping time period to obtain the DMSP/OLS night light data set fitted in the non-overlapping time period; wherein the DMSP/OLS night light data set fitted in an overlapping period and the DMSP/OLS night light data set fitted in the non-overlapping period form a complete reconstructed light data set;
a multi-source data integrating module, which is configured to integrate the reconstructed light data set and the DMSP/OLS night light data set to obtain complete data after multi-source integration.
